(19) United States
(12) Patent Application Publication
(10) Pub. No.: US 2020/0288735 A1
(43) Pub. Date: Sep. 17, 2020

(54) USE OF CELLOBIOSE OXIDASE FOR REDUCTION OF MAILLARD REACTION

(71) Applicant: Chr. Hansen A/S, Hoersholm (DK)

(72) Inventors: Martin LUND, Hoersholm (DK); Camilla Lund NIKOLAJSEN, Hoersholm (DK); Johannes Maarten VAN DEN BRINK, Hoersholm (DK)

(73) Assignee: Chr. Hansen A/S, Hoersholm (DK)

(21) Appl. No.: 16/769,378

(22) PCT Filed: Dec. 3, 2018
(86) PCT No.: PCT/EP2018/083333

§ 371 Date: Jun. 3, 2020

(30) Foreign Application Priority Data
Dec. 5, 2017 (EP) 17205321.7
May 24, 2018 (EP) 18173954.1

(51) Int. Cl. A23C 9/12; A23C 19/05; A23C 19/068; A23C 19/09; A23L 5/20; A23L 5/41; A23L 29/00

(52) U.S. Cl. CPC A23C 9/1213; A23C 19/054; A23C 19/0684; A23V 2002/00; A23L 5/25; A23L 5/41; A23L 29/06; A23C 19/09

(57) ABSTRACT

A process for the reduction of Maillard reaction (and thereby browning) in a food or feed product (preferably a dairy food product such as e.g. mozzarella cheese), wherein the process comprisescontacting the product with a cellobiose oxidase EC 1.1.99.18 enzyme.

### FIELD OF THE INVENTION

The present invention relates to a process for the reduction of the Maillard reaction (and thereby browning) in a food or feed product (preferably a dairy food product such as e.g. mozzarella cheese), wherein the process comprises contacting the product with a cellobiose oxidase EC 1.1.99.18 enzyme.

### BACKGROUND ART

A relatively high concentration of galactose can result in “browning” during heating of cheeses as it is often described when e.g. mozzarella cheese, produced by using S. thermophilus (ST), is used for e.g. pizza production.

The browning phenomenon is believed to be due to the Maillard reaction where galactose as reducing sugar is reacting with amino groups of amino acids/peptides.

Besides this major problem during pizza cheese production, excess amounts of free galactose can also lead to post acidification problems and imbalance in the flora of other dairy product, such as e.g. soft cheeses.

Many pizza manufacturers bake pizza at temperatures >260° C. At these high temperatures the propensity of the cheese to brown excessively has become a particular concern to the mozzarella industry.

WO02/39828A2 (Danisco) describes use of hexose oxidase (HOX) (EC1.1.3.5) enzyme for reduction of Maillard reaction (and thereby browning) in a cheese such as mozzarella cheese.

Hexose oxidase (EC1.1.3.5) uses “Cu cation” as active cofactor and cellobiose oxidase (EC 1.1.99.18) uses flavin adenine dinucleotide (FAD) as cofactor-—for this reason and others, they are different enzymes and therefore have different Enzyme Commission classification number (EC number).

The commercially available product LactoYIELD® (Chr. Hansen A/S, Denmark) comprises a cellobiose oxidase (EC 1.1.99.18), which herein alternatively may be termed lactose oxidase (LOX) or carbohydrate oxidase.

EP1041890B1 (Novozymes) and the article of Feng Xu et al (Eur. J. Biochem. 268, 1136-1142 (2001)) describe the cellobiose oxidase (EC 1.1.99.18) as present in LactoYIELD®—these prior art documents do no describe use of the cellobiose oxidase (EC 1.1.99.18) for reduction of the Maillard reaction (and thereby browning) in a food or feed product such as e.g. mozzarella cheese.

The mature amino acid sequence of the cellobiose oxidase (EC 1.1.99.18) as present in LactoYIELD® is position 23-495 of SEQ ID NO: 2 of EP1041890B1, which starts with Gly in position 23 and ends with Lys in position 495.

The polypeptide of position 23-495 of SEQ ID NO: 2 of EP1041890B1 is provided herein as position 1-473 of SEQ ID NO: 1.

EP2988601B1 (Arla) paragraph [0014] reads: “It has surprisingly been found that a process for oxidizing lactose in milk and milk-related products to lactobionic acid is effective for reducing off-flavor, e.g. “cooked” flavor, in a milk-related product, such as a high-temperature treated milk-related product. At the same time, it has been found that to maintain the flavor and shelf life of the milk-related product, lactose oxidizing should be kept low.” In working Examples LactoYIELD® is used for oxidizing lactose in milk. Reducing the so-called off-flavor in UHT milk by oxidizing lactose in the milk may objectively be seen as, not directly and unambiguously, related to use of e.g. LactoYIELD® to get a significant reduced amount of galactose and thereby less browning as discussed herein.

It is evident for the skilled person that UHT milk as discussed in EP2988601B1 (Arla) is not a lactic acid bacteria (LAB) fermented milk product (such as e.g. a yogurt product) or cheese dairy product.

### SUMMARY OF THE INVENTION

The problem to be solved by the present invention is to provide a novel process for the reduction of the Maillard reaction (and thereby browning) in a food or feed product (preferably a dairy food product such as e.g. a cheese—more preferably a mozzarella cheese).

The solution is based on that the present invention identified that the cellobiose oxidase (EC 1.1.99.18) enzyme as present in LactoYIELD® is good at solving the above-mentioned problem (see e.g. working Examples herein).

As discussed above—cellobiose oxidase (EC 1.1.99.18) may alternatively be termed lactose oxidase (LOX) or carbohydrate oxidase.

In Example 1 LactoYIELD® was added to the surface of a shredded mozzarella cheese and after 14 days of cold storage there was obtained a significant reduction of galactose and browning (after heating to 100° C. for 70 min) was significantly reduced.

Example 2 demonstrates that LactoYIELD® (LOX) is more heat stable than hexose oxidase (HOX) described in above discussed WO02/39828A2 (Danisco).

This is a significant advantage of LOX over HOX, since e.g. a number of food/feed products (e.g. dairy food products) are made by a process that involves a heating step.

For instance, Mozzarella cheese is made by a process that involves a heating step. As known in the art—Mozzarella is made by the so-called the pasta filata method (i.e. Mozzarella is an example of a so-called pasta filata cheese).

Cheeses manufactured by the pasta filata technique may undergo a plasticizing and kneading treatment of the fresh curd in hot water (i.e. a heating step, where the temperature may e.g. be from 50 to 95° C.).

Example 3 shows that by addition of LactoYIELD® (LOX) directly to the milk before acidification of the milk it was possible to make a cheese product comprising a significant reduced amount of galactose.

Above discussed, WO02/39828A2 (Danisco) briefly mentions the possibility of addition of the therein described HOX enzyme directly to the milk on page 7, lines 25-32. However, in none of the working Examples of WO02/39828A2 (Danisco) were the HOX enzyme added directly to the milk—i.e. it is simply mentioned as a theoretical possibility. As discussed above, Example 2 herein demonstrates that LactoYIELD® (LOX) is more heat stable than hexose oxidase (HOX) described in above discussed WO02/39828A2 (Danisco)—accordingly, if HOX is added directly to the milk one may expect that a subsequent heating step (e.g. as discussed above for Mozzarella manufacturing) would be more damaging to HOX than to LOX.

Example 4 shows that LactoYIELD® (LOX) works well for reducing browning even in presence of anticaking agents.

In summary, working examples herein demonstrate that the cellobiose oxidase (EC 1.1.99.18) enzyme as present in LactoYIELD® is good at reducing the Maillard reaction (and thereby reducing the browning problem) in a food or feed product.

Further, results of our working examples make it plausible that LOX is better than (HOX) described in WO02/39828A2 (Danisco) in relation to solving this problem.

There is prima facie no reason to believe that the herein discussed positive results should not be generally obtained by use of other suitable cellobiose oxidase (EC 1.1.99.18) enzyme.

A reason for this is that enzymes of the same EC class generally have a number of features in common, which may be seen as a technical reason for that they are designated in the same EC class.

Accordingly, a first aspect of the invention relates to a process for the reduction of Maillard reaction in a food or feed product (preferably a dairy food product), wherein the process comprises contacting the product with a cellobiose oxidase EC 1.1.99.18 enzyme.

Alternatively expressed, the first aspect and herein relevant embodiments thereof may be formulated as use of a cellobiose oxidase EC 1.1.99.18 enzyme for the reduction of Maillard reaction in a food or feed product (preferably a dairy food product), wherein the use involves a process comprising contacting the product with a cellobiose oxidase EC 1.1.99.18 enzyme.

The skilled person may routinely determine if an enzyme of interest is an enzyme with the Enzyme Commission number (EC number) EC 1.1.99.18 or not.

As discussed above, Hexose oxidase (EC1.1.3.5) uses “Cu cation” as active cofactor and cellobiose oxidase (EC 1.1.99.18) uses flavin adenine dinucleotide (FAD) as cofactor—for this reason and others, they are different enzymes and they therefore have different Enzyme Commission classification numbers (EC numbers).

Said in other words and as understood by the skilled person in the present context—the first aspect does not cover a process not involving contacting the product with a cellobiose oxidase EC 1.1.99.18 enzyme—i.e. it for instance does not cover a process that only involves use of e.g. a hexose oxidase EC1.1.3.5 enzyme.

As understood by the skilled person in the present context—the term “reduction of Maillard reaction” relates to that the extent of a Maillard reaction is reduced and/or the period of time required for completion of a Maillard reaction is increased.

Embodiment of the present invention is described below, by way of examples only. As understood by the skilled person in the present context, a combination of a preferred embodiment with another preferred embodiment may be seen as an even more preferred embodiment.

### DRAWINGS

FIG. 1: Test of browning of mozzarella cheese shreds. Single shreds placed in well and plate heated at 100° C. for 75 min. Each column shows replicates of cheese subjected to different treatment with LOX. Samples 1-3: Shreds of Mozzarella cheese made using Hannilase XP, treated with LOX and stored for 14 days at 5° C. 1: control with no LOX, 2: 0.01 LOXU/g, 3: 0.02 LOXU/g. Samples 10-12: Mozzarella cheese made using CHY-MAX M, treated with LOX and stored for 14 days at 5° C. 10: control with no LOX, 11: 0.01 LOXU/g, 12: 0.02 LOXU/g.

FIG. 2: Same sample treatment as in FIG. 1, but with addition of catalase Catazyme (0.1 U per g cheese).

FIG. 3: Data demonstrating that LactoYIELD® (LOX) works even in presence of anti-caking agents—see Example 3 herein for further details. Black 0 LOXU/g, blue 0.01 LOXU/g, red 0.05 LOXU/g. Vat 4 is a control cheese sample with high level of galactose (>0.5%) and Gouda45+is a control cheese sample with no or very little residual galactose.

FIG. 4: A: tested right after preparation of curd. B: tested after storage of curd for 1 week at 5° C.

### DETAILED DESCRIPTION OF THE INVENTION

Cellobiose Oxidase (EC 1.1.99.18) Enzyme

Preferably, the cellobiose oxidase (EC 1.1.99.18) enzyme is an enzyme:

(i): comprising the polypeptide sequence of position 23-495 of SEQ ID NO: 2 of EP1041890B1, which starts with Gly in position 23 and ends with Lys in position 495; or

(ii): a variant of (i), wherein the variant comprises less than 20 (preferably less than 10, more preferably less than 5) amino acid alterations (preferably a substitution, a deletion or an insertion—most preferably a substitution) as compared to polypeptide sequence of (i).

The polypeptide of position 23-495 of SEQ ID NO: 2 of EP1041890B1 is provided herein as position 1-473 of SEQ ID NO: 1.

Accordingly, preferably the cellobiose oxidase (EC 1.1.99.18) enzyme is an enzyme:
(i): comprising the polypeptide sequence of position 1-473 of SEQ ID NO: 1, which starts with Gly in position 1 and ends with Lys in position 473; or
(ii): a variant of (i), wherein the variant comprises less than 20 (preferably less than 10, more preferably less than 5) amino acid alterations (preferably a substitution, a deletion or an insertion—most preferably a substitution) as compared to polypeptide sequence of (i).

Starting from an enzyme of interest (here the cellobiose oxidase (EC 1.1.99.18) enzyme of item (i) above)—it is routine work for the skilled person to make a variant with the same/similar cellobiose oxidase activity (e.g. by making so-called conservative changes—e.g. a change of an amino acid to similar amino acid (e.g. change of a hydrophobic amino acid to another hydrophobic amino acid).

Said in other words—it is routine work for the skilled person to make a variant of item (ii) above—accordingly, it is not believed necessary to describe/discuss this in great details herein.

Preferred Process Parameters

Based on the technical teaching herein and the common general knowledge of the skilled person, it is routine work for the skilled person to optimize relevant process parameters (e.g. temperature, time, amount of enzyme used, etc.) in order to get reduction of Maillard reaction (and thereby browning) in a food or feed product (preferably a dairy food product)—accordingly, it is herein not required to describe this in great details.

The enzyme may be contacted with food or feed product during its preparation or it may be contacted with the foodstuff after the product has been prepared yet before the food or feed product is subjected to conditions which may result in the undesirable Maillard reaction. In the former aspect the enzyme will be incorporated in the foodstuff. In the later aspect the enzyme will be present on the surface of the foodstuff. When present on the surface Maillard reaction is still prevented as it is the surface of a material exposed to drying and atmospheric oxygen which undergoes the predominant Maillard reaction.

When contacted with food or feed product during its preparation the enzyme may be contacted at any suitable stage during its production. In the aspect that the foodstuff is a dairy product it may be contacted with the milk during acidification of the milk and precipitation of the milk curd. In this process the enzyme may not be active during the anaerobic conditions created during the acidification and milk protein precipitation but will be active in the dairy product such as cheese when aerobic conditions are created. Once in aerobic conditions the enzyme oxidizes the reducing sugar and reduces the tendency to Maillard reaction.

For application of the enzyme to the surface of the food or feed product, one may apply the enzyme in any suitable manner.

Typically, the enzyme is provided in a solution or dispersion and sprayed on the food-stuff. The solution/dispersion may comprise the enzyme in an amount of 1-50 units enzyme/ml.

The enzyme may also be added in dry or powder form. When in wet or dry form the enzyme may be combined with other components for contact with the foodstuff. For example, when the enzyme is in dry form it may be combined with an anticaking agent.

In some aspects the present invention further comprises the step of contacting the food or feed product with a catalase.

In a preferred aspect the food or feed product is packaged within an oxygen impermeable container after contact with the enzyme. We have identified that the enzyme on action with the reducing sugar may consume oxygen within a container. Consumption of the oxygen will reduce the microbiological activity in the food/feed product and improve the shelf life. The normal practice of packaging in controlled atmosphere may then be dispensed with.

It will be appreciated by one skilled in the art that in the practice of the present invention one contacts the dairy food product with a sufficient amount of enzyme to prevent and/or reduce a Maillard reaction—it is routine work for the skilled person to identify such a sufficient amount of enzyme.

Typical amounts of enzyme which may be contacted with the foodstuff are from 0.05 to 5 U/g (units of enzyme per gram of food product), from 0.05 to 3 U/g, from 0.05 to 2 U/g, from 0.1 to 2 U/g, from 0.1 to 1.5 U/g, and from 0.5 to 1.5 U/g.

As discussed in working Example herein—the amount of LactoYIELD® (LOX) may be determined according to the public known so-called LOXU/g unit.

LOXU/g unit is public available/known (and thereby possible to determine for the skilled person) from the public available Product Information sheet for LactoYIELD®, Chr. Hansen A/S Denmark; Version: 5 PI GLOB EN 02-24-2017—the Product Information sheet for LactoYIELD® may be obtained upon request to Chr. Hansen A/S Denmark or by simply buying of the LactoYIELD® product.

It may be preferred that typical amounts of cellobiose oxidase (EC 1.1.99.18) enzyme which may be contacted with the foodstuff are from 0.0001 to 10.0 LOXU/g, such as from 0.001 to 5.0 LOXU/g or more preferably from 0.001 to 1.0 LOXU/g or even more preferably from 0.005 to 0.1 LOXU/g.

As discussed above, Example 3 shows that by addition of LactoYIELD® (LOX) directly to the milk before acidification of the milk it was possible to make a cheese product comprising a significant reduced amount of galactose.

Accordingly, a preferred embodiment may relate to a process for the reduction of Maillard reaction in a dairy food product, wherein the process comprises following steps:

(a): contacting milk with cellobiose oxidase (EC 1.1.99.18) enzyme of first aspect and/or any embodiments thereof before, during or after acidification of the milk; and

(d): making further adequate steps to finally end up with the dairy food product comprising a reduced amount of galactose and thereby a product with a reduction of Maillard reaction.

It may be preferred that the dairy food product is a cheese food product, where a preferred embodiment may relate to a process for the reduction of Maillard reaction in a cheese food product, wherein the process comprises following steps:

(a): contacting milk with cellobiose oxidase (EC 1.1.99.18) enzyme of first aspect and/or any embodiments thereof before, during or after acidification of the milk;

(b) coagulating the acidified milk of (i) and separating the curd from the whey;

(c): storing the curd of (ii) under conditions, where the oxidase enzymes present in the curd performs oxidation of galactose present in the curd;

(d): making further adequate steps to finally end up with the cheese product comprising a reduced amount of galactose and thereby a product with a reduction of Maillard reaction.

In relation to step (a) above—the enzyme may be contacted with the milk in any suitable form—e.g. contacting liquid enzyme with the milk.

As discussed below in relation to the conclusions of working Example 3—adsorption of LOX onto a particle avoids the transfer of the enzyme to whey. This not only preserves the value of whey, but also allows one to dose only a tenth of the required enzyme. Presence of LOX in cheese curd catalyzes the oxidation of galactose to galactonic acid which will result in reduced browning upon baking.

Above discussed WO02/39828A2 (Danisco) does not even mention the possibility of adsorption of the therein described hexose oxidase (HOX) enzyme onto particles.

Accordingly, preferably step (a) above is contacting milk with particles comprising bound/encapsulated cellobiose oxidase (EC 1.1.99.18) enzymes before, during or after acidification of the milk.

It may be preferred that the dairy food product is a cheese food product, where a prefer embodiment may relate to a process for the reduction of Maillard reaction in a cheese food product, wherein the process comprises following steps:

(a): contacting milk with particles comprising bound/encapsulated cellobiose oxidase (EC 1.1.99.18) enzyme of first aspect and/or any embodiments thereof before, during or after acidification of the milk;

(b) coagulating the acidified milk of (i) and separating the curd from the whey;

(c): storing the curd of (ii) under conditions, where the oxidase enzymes present in the curd performs oxidation of galactose present in the curd;

(d): making further adequate steps to finally end up with the cheese product comprising a reduced amount of galactose and thereby a product with a reduction of Maillard reaction.

Working Example 3 describes particles with a particle diameter distribution that works very well—i.e. avoids the transfer of the enzyme to whey.

There is no reason to believe that particles with a relatively lower/higher particle diameter distribution than used in Example 3 should not work reasonably well.

Accordingly, in a preferred embodiment the particles comprising bound/encapsulated oxidase enzyme of step (a) are particles having a particle diameter (D(v,0.1)) distribution of at least 10 nm and a particle diameter (D(v,0.9)) distribution of less than 500 μm—more preferably a particle diameter (D(v,0.1)) distribution of at least 0.1 μm and a particle diameter (D(v,0.9)) distribution of less than 200 μm—even more preferably a particle diameter (D(v,0.1)) distribution of at least 0.5 μm and a particle diameter (D(v,0.9)) distribution of less than 100 μm.

According to the art, the term “D(v,0.1)” represents the particle diameter at which 10% of the particle distribution is below and “D(v,0.9)” represents the particle diameter at which 90% of the particle distribution is below.

Consequently, if e.g. D(v,0.1)=2 μm and D(v,0.9)=200 μm then will there be relatively many (more than 90%) of the particles that have a particle diameter above 2 μm and there will be relatively many (at least 90%) of the particles that have a particle diameter less than 200 μm=>the majority of the particles will have a particle diameter within the range from 2 μm to 200 μm.

As known in the art—in relation to irregularly shaped particles the concept of “equivalent spherical diameter” is generally used, in which some physical property of the particle is related to a sphere that would have the same property (e.g. same volume)—accordingly, particle diameter relates herein the well-known concept of “equivalent spherical diameter”.

According to the art—the term “v” in the term “D(v,0.1)” and “D(v,0.9)” relates to volume—i.e. volume distribution.

It is routine work for the skilled person to measure the herein relevant “D(v,0.1)” and “D(v,0.9)” values—e.g. by using a suitable Malvern apparatus or another suitable apparatus.

In working Example 3 herein the particles of step (a) was made of agarose.

The skilled person knows a number of suitable different particle types that are acceptable/authorized for food/feed product manufacturing and any of such suitable particle types may in principle be used as step (a) suitable particle types.

It may be preferred that the particles in step (a) are at least one particle type selected from the group consisting of: cellulose and derivatives hereof, agarose, dextran, polymers such as e. g. polyacrylates, polystyrene, polyacrylamide, polymethacrylate or copolymers.

As evident to the skilled person in the present context—the term “at least one” refers to that the particles in step (a) may of course be different particle types—e.g. 50% of one type and 50% of another type.

The international patent application with PCT application number: PCT/EP2018/050317 was filed 8 January 2018 and still not published at the filing date of the present application.

PCT/EP2018/050317 describes particles—so-called CGMP oligomer particles—wherein CGMP oligomer is cross-linked, via intermolecular covalent isopeptide bonds, casein glycomacropeptide (CGMP) oligomers (CGMP oligomers), wherein monomeric CGMP is the peptide containing the amino acid residues 106-169 of κ-casein and monomers of CGMP oligomers are monomeric CGMP.

Working Example 6 of PCT/EP2018/050317 describes CGMP oligomer particles comprising encapsulation lactose oxidase (LOX, LactoYIELD®).

PCT/EP2018/050317 does not directly and unambiguously disclose use of LOX in a process for the reduction of Maillard reaction in a food or feed product as discussed herein—for instance, the term “browning” is not even mentioned in PCT/EP2018/050317.

It may be preferred that the particles in step (a) are at least one particle type selected from the group consisting of: CGMP oligomer particles, wherein CGMP oligomer is cross-linked, via intermolecular covalent isopeptide bonds, casein glycomacropeptide (CGMP) oligomers (CGMP oligomers), wherein monomeric CGMP is the peptide containing the amino acid residues 106-169 of K-casein and monomers of CGMP oligomers are monomeric CGMP.

Food or Feed Product

Useful food/feed product starting materials include any relevant material—e.g. material which is conventionally subjected to a lactic acid bacterial fermentation step such as milk (e.g. soy milk or cow milk, preferably cow milk), vegetable materials, meat products, fruit juices, must, doughs and batters.

Preferably, the product is a dairy food product, preferably a fermented dairy food product.

The fermented products, which are obtained by the method, include as typical examples dairy products such as fermented milk, yogurt, cheese, including fresh cheese products, soft cheese products, cheddar, mozzarella or buttermilk.

In a preferred embodiment, the dairy product is soft cheese, cheddar cheese, pasta filata cheese or mozzarella cheese—more preferably, the dairy product is pasta filata cheese, cheddar cheese or mozzarella cheese—most preferably the dairy product is mozzarella cheese or cheddar cheese (preferably used for making pizza).

As discussed above—Example 2 herein demonstrates that LactoYIELD® (LOX) is more heat stable than hexose oxidase (HOX) described in above discussed WO02/39828A2 (Danisco).

This is a significant advantage of LOX over HOX, since e.g. a number of food/feed products (e.g. dairy food products) are made by a process that involves a heating step.

For instance, Mozzarella cheese is made by a process that involves a heating step. As known in the art—Mozzarella is made by the so-called the pasta filata method (i.e. Mozzarella is an example of a so-called pasta filata cheese).

Cheeses manufactured from the pasta filata technique may undergo a plasticizing and kneading treatment of the fresh curd in hot water (i.e. a heating step, where the temperature may e.g. be from 50 to 95° C.).

Accordingly, in a preferred embodiment the food or feed product is a product made by a process that involves a heating step and the contacting of the product with the cellobiose oxidase (EC 1.1.99.18) enzyme has been done before the heating step is made. In relation to this embodiment, a preferred product may be a pasta filata cheese (such as e.g. Mozzarella cheese).

The heating step may e.g. be a heating step to a temperature above 40° C., such as above 50° C. or such as above 70° C.

As discussed above, many pizza manufacturers bake pizza at temperatures >260° C. and there may then be significant browning problems.

Accordingly, in a preferred embodiment the food or feed product is a product used in a process (e.g. for making pizza) involving a heating step to a temperature above 40° C., such as above 80° C. or such as above 100° C. or such as above 150° C.

In relation to this embodiment, a preferred product may be a pasta filata cheese (such as e.g. Mozzarella cheese)—which may be used for making pizza or alternatively expressed pizza cheese.

Shredded cheese (such as e.g. mozzarella) commercially available for the consumer normally contains anticaking agent. The role of anticaking agent is to prevent shreds of cheese from sticking to each other and forming a lump of cheese that cannot be spread easily on e.g. a pizza.

Anti-caking agent is normally composed of starch from e.g. potato and corn. Since starch is a natural polysaccharide containing high amounts of reducing sugar groups one would anticipate starch to contribute significantly to Maillard browning. Thus, a solution only controlling galactose reduction may not be useful for a shredded product with applied anticaking agents such as starch.

Example 4 shows that LactoYIELD® (LOX) works well even in presence of starch anti-caking agents—more specially for making shredded mozzarella cheese product comprising starch anticaking agents.

Accordingly, in a preferred embodiment the food or feed product (preferably a food product, such as preferably a shredded cheese product (e.g. mozzarella cheese) is a product comprising starch anticaking agents (e.g. starch from potato and/or corn).

As known in the art—the term “shredded cheese” relates to a cheese that has been sent through a shredder to create shreds of cheese. Shredded cheese is generally used as an ingredient. It is mixed in with other ingredients or used as a topping for foods such as salads, sandwiches, soup, pizza, lasagna, and many other savory dishes. It is available in many different varieties, such as mozzarella, Cheddar, Parmesan, and Swiss.

Accordingly, preferably the shredded cheese is a mozzarella shredded cheese, a Cheddar shredded cheese, a Parmesan shredded cheese or a Swiss shredded cheese.

In further embodiments, the substrate material is a starting material for an animal feed such as silage, e. g. grass, cereal material, peas, alfalfa or sugar-beet leaf, where bacterial cultures are inoculated in the feed crop to be ensiled in order to obtain a preservation hereof, or in protein rich animal waste products such as slaughtering offal and fish offal, also with the aims of preserving this offal for animal feeding purposes.

Separate Aspect of the Invention

As discussed above in relation to the conclusions of working Example 3—adsorption of LOX onto a particle avoids the transfer of the enzyme to whey. This not only preserves the value of whey, but also allows one to dose only a tenth of the required enzyme. Presence of LOX in cheese curd catalyzes the oxidation of galactose to galactonic acid which will result in reduced browning upon baking.

Above discussed WO02/39828A2 (Danisco) does not even mention the possibility of adsorption of the therein described hexose oxidase (HOX) enzyme onto particles.

Without being limited to theory—there is prima facie no reason to believe that adsorption of HOX onto a particle could not give an improved process over the processes described in above discussed WO02/39828A2 (Danisco), where all working examples essentially only describes “spray on” addition of the HOX enzyme to the surface of the product (e.g. mozzarella cheese).

Accordingly, a separate aspect of the invention relates to a process for the reduction of Maillard reaction in a cheese food product, wherein the process comprises following steps:

(a): contacting milk with particles comprising bound/encapsulated hexose oxidase (EC1.1.3.5) and/or cellobiose oxidase (EC 1.1.99.18) enzyme of first aspect and/or any embodiments thereof before, during or after acidification of the milk;

(b) coagulating the acidified milk of (i) and separating the curd from the whey;

(c): storing the curd of (ii) under conditions, where the oxidase enzymes present in the curd performs oxidation of galactose present in the curd;

(d): making further adequate steps to finally end up with the cheese product comprising a reduced amount of galactose and thereby a product with a reduction of Maillard reaction.

The full length polypeptide sequence (including pre/signal sequence—i.e. upstream of mature peptide) of the hexose oxidase (HOX) enzyme discussed in WO02/39828A2 (Danisco) is shown herein as polypeptide sequence of position of SEQ ID NO: 2. It has CAS NO:9028-75-5 and UniProt reference number “UniProtKB-P93762 (HOX_CHOCR)” (http://www.uniprotorg/uniprot/P93762).

Preferably, the hexose oxidase enzyme is an enzyme:
(i): comprising the mature/active part of the polypeptide sequence of SEQ ID NO: 2 herein; or
(ii): a variant of (i), wherein the variant comprises less than 20 (preferably less than 10, more preferably less than 5) amino acid alterations (preferably a substitution, a deletion or an insertion—most preferably a substitution) as compared to polypeptide sequence of (i).

An example of a mature/active part of the polypeptide sequence of SEQ ID NO: 2 herein of item (i) is the HOX enzyme commercial available Danisco/DuPont product Grindamyl Surebake 800—it is used in a working example herein.

Above described preferred embodiments (e.g. relating to preferred particle types; preferred particle diameter; preferred cheese food product; etc.) are also preferred embodiments of above separate aspect of the invention.

### EXAMPLES

### Example 1

### LactoYIELD® (LOX) Experimental Data

Below is referred to that enzyme dosage was LOXU per g cheese.

LOXU was determined according to the public available Product Information sheet for LactoYIELD®, Chr. Hansen A/S Denmark; Version: 5 PI GLOB EN 02-24-2017.

As discussed below—in this Example were used around 0.01-0.02 LOXU/g.

In this experiment LactoYield was added to the surface of a shredded mozzarella cheese. A mozzarella cheese produced either using Hannilase XP (mucor pepsin XL-type) or CHY-MAX M (camel chymosin) and the same culture was shredded and stored at —18° C. An amount of 5.0 g of cheese shreds was transferred to a 15 ml tube and added 0.5 ml LactoYield enzyme diluted in 0.05 M sodium acetate pH 5.2. Enzyme dosage was 0, 0.01 or 0.02 LOXU per g cheese. The tube was closed with an air tight lid, inverted for 20 min and stored at 5° C. After 14 days of storage the sample was analyzed for ability to brown and for galactose.

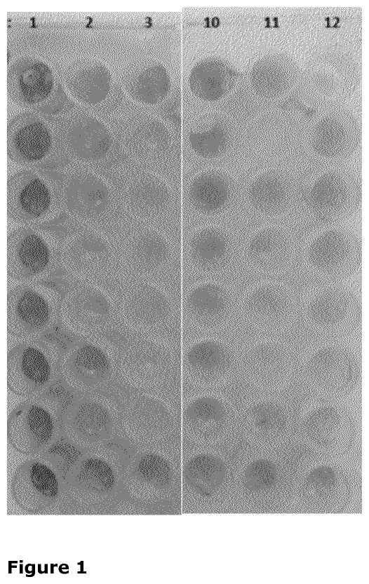

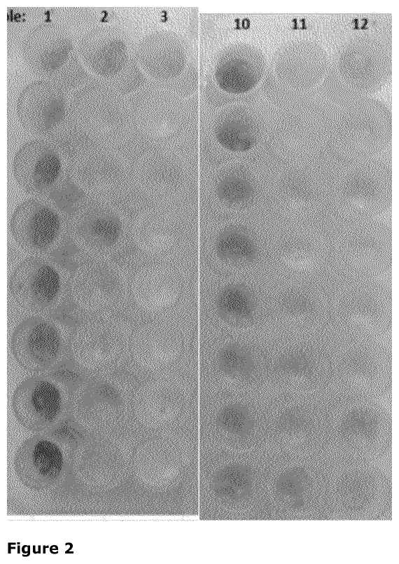

Browning was studied by placing single shreds of cheese in a well of a 96 well plate. The plate was heated to 100° C. for 70 min. From the result shown in FIG. 1 and FIG. 2 it is seen that treatment of shredded mozzarella cheese with LOX at 0.01-0.02 LOXU/g reduced the ability of the cheese to brown. Addition of catalase (Catazyme) seemed to increase the effect of the LactoYield enzyme and resulted in even less browning.

The sample was analyzed for galactose by dispersing 4 g cheese in 25 ml water to homogeneity and inverting the tube for 30 min. LOX enzyme in the suspension was inactivated by immersing the sample in a water bath at 80° C. for 25 min. The aqueous phase was recovered after centrifugation and kept at -18° C. before analysis. Galactose was quantified by HPLC. In Table 1 it is seen that the concentration of galactose declines to a level less than 200 mg/100 g when the sample of cheese is treated with LOX. Reduction of galactose upon LOX addition is in good agreement with the observed reduction of browning.

TABLE 1
Measurement of residual galactose in cheese shreds.

| | LactoYield | Catazyme | Residual galactose |
|---|---|---|---|
| Coagulant | (LOX-U/g) | (U/g) | (mg/100 g) |
| CHY-MAX M | 0 | 0 | 570 |
| CHY-MAX M | 0.01 | 0 | 318 |
| CHY-MAX M | 0.02 | 0 | 200 |
| Hannilase | 0 | 0 | 575 |
| Hannilase | 0.01 | 0 | 304 |
| Hannilase | 0.02 | 0 | 249 |
| CHY-MAX M | 0 | 0.1 | 543 |
| CHY-MAX M | 0.01 | 0.1 | 331 |
| CHY-MAX M | 0.02 | 0.1 | 158 |
| Hannilase | 0 | 0.1 | 584 |
| Hannilase | 0.01 | 0.1 | 340 |
| Hannilase | 0.02 | 0.1 | 296 |

### Example 2

### LactoYield (LOX) is more Heat Stable than HOX

An inherent step in production of pasta filata cheese is heat stretching of the curd. Here freshly made loaves of curd are subjected to hot water in a stretching process that serves to plasticize the curd. In the so called cooker curd is stretched in water having temperatures up to e.g. 80-85° C. for holding times of 2-3 min. The treatment results in curd temperatures as high as 65-70° C. The activity of enzymes that are added to cheese milk and retained in curd must be preserved during the entire process of cheese making. To assess the potential impact of a heat treatment of LOX, a buffered solution of the enzyme was heated to temperatures in the range 50-80° C. for various holding times from 5-30 min. The buffer employed was a 50 mM sodium acetate of pH 5.2, which is the target pH of mozzarella curd entering heat stretching. After heating the enzyme was placed on ice and activity was measured. The enzymes HOX (commercial available Danisco/DuPont product Grindamyl Surebake 800 described in above discussed WO02/39828A2) and GOX (Glucose oxidase—commercially available product G6125 from Sigma) were included as reference. The same assay was used for all measurement of enzyme activity of the three enzymes. Activity measurement was done in a coupled peroxidase assay using 4-aminoantipyrine (4AA) and N-ethyl-N-sul-fopropyl-m-toluidine (Tops) as the chromogenic agents according to Eur. J. Biochem. 268, 1136-1142 (2001). Activity was converted to relative activity by normalizing to activity of an untreated control sample of the respective enzyme at same dilution. Plotting activity as function of holding time resulted in a single exponential decay from which a rate constant was calculated. From the Arrhenius equation describing the relationship between rate constant and temperature, rate constants were calculated at temperatures 50-72° C. and converted into half-life values for a 1^{st} order reaction.

In Table 2 it is seen that LOX is stable at temperatures 65-72° C. whereas GOX and HOX have lost considerable activity within 2-5 min.

TABLE 2
Half-life values in min for heat inactivation
of LOX, GOX and HOX at pH 5.2.

| | t_{1/2} | t_{1/2} | t_{1/2} | t_{1/2} | t_{1/2} | t_{1/2} |
|---|---|---|---|---|---|---|
| Enzyme | (50° C.) | (55 C. °) | (60 C. °) | (65° C.) | (70° C.) | (72° C.) |
| LOX | 3763 | 912 | 231 | 60.8 | 16.7 | 10.0 |
| GOX | 101 | 39.2 | 15.7 | 6.42 | 2.71 | 1.93 |
| HOX | 57.4 | 24.6 | 10.8 | 4.89 | 2.26 | 1.67 |

### Example 3

### Addition of LactoYield (LOX) to Cheese Milk—Particles Best

Below is referred to enzyme “bound to particles” —the particles had a particle diameter (D(v,0.1)) distribution of at least 2 μm and a particle diameter (D(v,0.9)) distribution of less than 200 μm.

The particle was made of agarose (Workbeads WB40S)-D(v,0.5) of 40 μm.

A down scaled cheese model was made in 96 well plates employing a process simulating cheese making. Skim milk was added CaCl₂ to 0.5 g/I, glucono delta-lactoneglucone (GDL) to 0.9 g/I for chemical acidification and Ha-lactase to 5 NLU/ml for hydrolyzing lactose to glucose and galactose. Immediately after dissolving GDL, the milk was transferred to a 96 deep well plate with 1.25 ml in each well. The enzyme LactoYield (LOX) was added at different levels either as liquid enzyme or as bound to particles with particle diameter as given above. Catalase was added as liquid enzyme at different levels. Addition of LOX marked start of the experiment (t=0). The plate was heated to 30° C. and was mixed by shaking. At t=10 min coagulant was added to each well (0.04 IMCU/ml) and shaking of the plate stopped five minutes later. Addition of coagulant resulted in coagulation of the milk to rennet curd. At t=35 min the curd was cut by moving a pipette tip back and forth a few times before increasing temperature to 40° C. and starting shaking of the plate. At t=60 min part of the whey was removed and displaced with water and shaking continued. A sample of whey was kept for analysis of LOX activity. Finally, at t=70 min, the plate was spun in a centrifuge at 3000 ppm for 20 min and whey was removed by inversion of the plate. In the plate remained a small piece of rennet curd. The curd was stored at 5° C. and samples were taken for analysis after 0, 4, 8, and 12 days. Curd was dissolved in 1.0 ml 0.5 M Na3-citrate, and sugar extracted from the dissolved rennet curd by lowering pH to 4.5 with hydrochloric acid and taking a sample of the supernatant after centrifugation. Galactose was analyzed using an enzymatic assay kit from Megazyme (K-LACGAR). Activity of LOX in whey was measured using a colorimetric assay employing 2,6-dichloroindophenol as electron acceptor.

The results demonstrated that a significant fraction of the LOX activity is transferred to whey when the enzyme is added as a liquid formulation. When the LOX enzyme is bound to a 40 μm particle, the enzyme could not be detected in whey. This suggests that the enzyme partitions selectively to curd when associated with a micron size particle.

Results relating to development of galactose in the curd during storage at 5° C. showed that control without LOX added has the same content of galactose during the 13 days storage period. In curd made with LOX there is a decline in galactose during storage. At the end of storage galactose had decreased to <200 mg/100kg (<0.2%). This shows that the lactose oxidase had oxidized galactose to galactonic acid in cheese curd during storage. It is most likely that the reduction of galactose will result in the lower browning of the cheese curd.

In conclusion, adsorption of LOX onto a particle avoids the transfer of the enzyme to whey. This not only preserves the value of whey, but also allows one to dose only a tenth of the required enzyme. Presence of LOX in cheese curd catalyzes the oxidation of galactose to galactonic acid which will result in reduced browning upon baking.

### Example 4

### LactoYield (LOX) Works Even in Presence of Anticaking Agents

The experiment reported in Example 1 was based on cheese shredded for the purpose. Shredded cheese commercially available for the consumer always contains anticaking agent. The role of anticaking agent is to prevent shreds of cheese from sticking to each other and forming a lump of cheese that cannot be spread easily on e.g. a pizza. Anti-caking agent is composed of starch from e.g. potato and corn. Since starch is a natural polysaccharide containing high amounts of reducing sugar groups one would anticipate starch to contribute significantly to Maillard browning. Thus, a solution only controlling galactose reduction may not be useful for a shredded product applied with anticaking agents such as starch.

LOX can oxidize polymeric carbohydrates unlike its functional analogs, HOX and GOX (Eur. J. Biochem. 268, 1136-1142, 2001). To test if the activity of LOX towards starch was high enough to control browning of mozzarella cheese with anticaking agent, the experiment of Example 1 was repeated using shredded cheese from the supermarket having potato starch on the ingredient list.

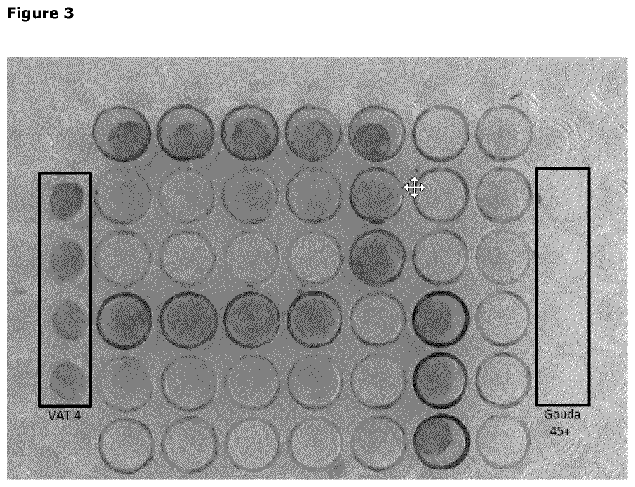

LOX was applied to the surface of shredded cheese and stored in tubes with tightly closed lids. After 2 weeks storage at 4° C. browning was tested. From the result shown in FIG. 3 herein it is seen that LOX treatment of shredded mozzarella cheese containing potato starch has a strong influence on the color of the cheese after heating to 100° C. for 100 min, where addition of LOX gave significant less browning.

Example 5

The effect of adding LOX to milk prior to cheese making was studied using a miniaturized cheese model. Micro cheese was prepared in 2 ml 96 deep well plates made of polypropylene. To each well was added 1.25 ml milk containing freshly added deltagluconolactone, calcium chloride, lactase and catalase. LOX was added at three dosages: no LOX, 0.1 LOXU/ml and 0.5 LOXU/ml. The plate was incubated at 32° C. with shaking for 10 min. Subsequently, the milk coagulant CHY-MAX was added to each well at a dosage of 0.04 IMCU/ml. Shaking was stopped 7 min after coagulant addition, and 18 min later the formed rennet gel (coagulum) was cut with a pipette tip. Right after cutting, temperature was increased to 40° C., and 5 min later shaking started. Shaking of the plate was done to mimic stirring of curd in the cheese vat. After 20 min of shaking 400 μl whey was removed from each well and replaced with 400 μl water to dilute sugars in curd and whey. Shaking of the plate at 40° C. was continued for 15 min, and then curd and whey was separated by centrifugation of the plate in a relative centrifugal field of 3214 g. Whey was decanted from the plate and the small pieces of rennet curd (cheese) remained in the plate. Finally, the plate was heated at 65° C. for 15 min to mimic heat stretching of pasta filata cheese. Two plates were made: one was tested for browning immediately after its preparation, and the other was stored at 5° C. before testing. Browning was testing by placing the 2 ml deep well plate in a plate heater for 2 hours at 100° C.

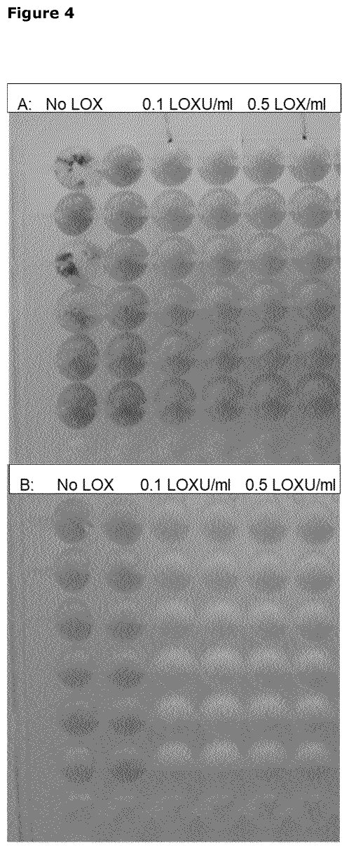

The browning test showed that all curd samples in the plate tested right after preparation of curd turned brown irrespective of enzyme dosage, whereas for curd in the plate stored for 1 week there was a significant reduction in browning at a LOX dosage of 0.1 LUXO/ml or higher (see FIG. 4 herein). This shows that addition of LOX to cheese milk prior to cheese making can be used for reducing browning of cheese by controlling the amount of residual reducing sugar. A fraction of the enzyme is retained in the curd, and during cold storage of the curd the retained enzyme will oxidize reducing sugars to their corresponding acids.

### REFERENCES

1: WO02/39828A2 (Danisco)

2: EP1041890B1 (Novozymes)

3: Article of Feng Xu et al (Eur. J. Biochem. 268, 1136-1142 (2001))

4: EP2988601B1 (Arla)

1. A process for the reduction of Maillard reaction in a food or feed product (preferably a dairy food product), wherein the process comprises contacting the product with a cellobiose oxidase EC 1.1.99.18 enzyme; and
wherein the oxidase enzyme is contacted with the food or feed product during its preparation or it is contacted with the food or feed product after the product has been prepared yet before the food or feed product is subjected to conditions which may result in the undesirable Maillard reaction; and
wherein the oxidase enzyme is contacted with the food or feed product under conditions, where the oxidase enzymes performs oxidation of galactose present in the food or feed product and/or where the oxidase enzymes performs oxidation of galactose present on the surface of the food or feed product.

2. The process of any of the preceding claims, wherein the cellobiose oxidase EC 1.1.99.18 enzyme is an enzyme:
(i): comprising the polypeptide sequence of position 1-473 of SEQ ID NO: 1, which starts with Gly in position 1 and ends with Lys in position 473; or
(ii): a variant of (i), wherein the variant comprises less than 20 (preferably less than 10, more preferably less than 5) amino acid alterations (preferably a substitution, a deletion or an insertion—most preferably a substitution) as compared to polypeptide sequence of (i).

3. The process of any of the preceding claims, wherein the cellobiose oxidase EC 1.1.99.18 enzyme is an enzyme:
(i): comprising the polypeptide sequence of position 1-473 of SEQ ID NO: 1, which starts with Gly in position 1 and ends with Lys in position 473; and
wherein the amount of cellobiose oxidase EC 1.1.99.18 enzyme that is contacted with the foodstuff is from 0.001 to 1.0 LOXU/g.

4. The process of any of the preceding claims, wherein the product is a dairy food product and the process comprises following steps:
(a): contacting milk with the cellobiose oxidase EC 1.1.99.18 enzyme before, during or after acidification of the milk; and
(d): making further adequate steps to finally end up with the dairy food product comprising a reduced amount of galactose and thereby a product with a reduction of Maillard reaction.

5. The process of claim 4, wherein the product is a cheese food product and wherein the process comprises following steps:
(a): contacting milk with the cellobiose oxidase EC 1.1.99.18 enzyme before, during or after acidification of the milk;
(b) coagulating the acidified milk of (i) and separating the curd from the whey;
(c): storing the curd of (ii) under conditions, where the oxidase enzymes present in the curd performs oxidation of galactose present in the curd;
(d): making further adequate steps to finally end up with the cheese product comprising a reduced amount of galactose and thereby a product with a reduction of Maillard reaction.

6. The process of any of claims 4-5, wherein step (a) above is contacting milk with particles comprising bound/encapsulated cellobiose oxidase EC 1.1.99.18 enzymes before, during or after acidification of the milk.

7. The process of claims 6, wherein the product is a cheese food product and wherein the process comprises following steps:
(a): contacting milk with particles comprising bound/encapsulated cellobiose oxidase EC 1.1.99.18 enzyme before, during or after acidification of the milk;
(b) coagulating the acidified milk of (i) and separating the curd from the whey;
(c): storing the curd of (ii) under conditions, where the oxidase enzymes present in the curd performs oxidation of galactose present in the curd;
(d): making further adequate steps to finally end up with the cheese product comprising a reduced amount of galactose and thereby a product with a reduction of Maillard reaction.

8. The process of any of the claims 6-7, wherein the particles comprising bound/encapsulated oxidase enzyme of step (a) are particles having a particle diameter (D(v,0.1)) distribution of at least 0.1 μm and a particle diameter (D(v,0.9)) distribution of less than 200 μm; and
wherein the particles in step (a) are at least one particle type selected from the group consisting of: cellulose and derivatives hereof, agarose, dextran, polymers such as e. g. polyacrylates, polystyrene, polyacrylamide, polymethacrylate, copolymers or CGMP oligomer particles, wherein CGMP oligomer is cross-linked, via intermolecular covalent isopeptide bonds, casein glycomacropeptide (CGMP) oligomers (CGMP oligomers), wherein monomeric CGMP is the peptide containing the amino acid residues 106-169 of κ-casein and monomers of CGMP oligomers are monomeric CGMP.

9. The process of any of the claims 1-3, wherein the cellobiose oxidase is contacted to the food or feed product by being sprayed on the product as a solution or dispersion.

10. The process of any of the preceding claims, wherein the product is a dairy food product and wherein the dairy product is a lactic acid bacteria (LAB) fermented milk product (such as e.g. a yogurt product) or a cheese product.

11. The process of claim 10, wherein the product is pasta filata cheese, preferably wherein the pasta filata cheese is a mozzarella cheese.

12. The process of any of the claims 10-11, wherein the product is a product made by a process that involves a heating step and the contacting of the product with the cellobiose oxidase EC 1.1.99.18 enzyme has been done before the heating step is made and wherein the heating step is a heating step to a temperature above 40° C.

13. The process of any of the preceding claims, wherein the product is a product used in a process (e.g. for making pizza) involving a heating step to a temperature above 100° C.; and wherein the product is a pasta filata cheese, preferably wherein the pasta filata cheese is a mozzarella cheese.

14. The process of any of the preceding claims, wherein the product is a shredded cheese product comprising starch anticaking agents (e.g. starch from potato and/or corn) and wherein the shredded cheese product is mozzarella cheese, cheddar cheese, parmesan cheese or Swiss cheese.

15. Use of a cellobiose oxidase EC 1.1.99.18 enzyme for the reduction of Maillard reaction in a food or feed product (preferably a dairy food product), wherein the use involves a process comprising contacting the product with a cellobiose oxidase EC 1.1.99.18 enzyme of any of the preceding claims.


SEQUENCE LISTING (2 sequences)

SEQ ID NO: 1 - protein, 473 aa, Microdochium nivale
  LOX
GAIEACLSAAGVPIDIPGTADYERDVEPFNIRLPYIPTAIAQTQTTAHIQSAVQCAKKLNLKVSAKSGGHSYASFGFGGENGHLMVQLDRMIDVISYNDKTGIAHVEPGARLGHLATVLNDKYGRAISHGTCPGVGISGHFAHGGFGFSSHMHGLAVDSVVGVTVVLADGRIVEASATENADLFWGIKGAGSNFGIVAVWKLATFPAPKVLTRFGVTLNWKNKTSALKGIEAVEDYARWVAPREVNFRIGDYGAGNPGIEGLYYGTPEQWRAAFQPLLDTLPAGYVVNPTTSLNWIESVLSYSNFDHVDFITPQPVENFYAKSLTLKSIKGDAVKNFVDYYFDVSNKVKDRFWFYQLDVHGGKNSQVTKVTNAETAYPHRDKLWLIQFYDRYDNNQTYPETSFKFLDGWVNSVTKALPKSDWGMYINYADPRMDRDYATKVYYGENLARLQKLKAKFDPTDRFYYPQAVRPVK

SEQ ID NO: 2 - protein, 546 aa, Chondrus crispus
  HOX
MATLPQKDPGYIVIDVNAGTPDKPDPRLPSMKQGFNRRWIGTNIDFVYVVYTPQGACTALDRAMEKCSPGTVRIVSGGHCYEDFVFDECVKAIINVTGLVESGYDDDRGYFVSSGDTNWGSFKTLFRDHGRVLPGGSCYSVGLGGHIVGGGDGILARLHGLPVDWLSGVEVVVKPVLTEDSVLKYVHKDSEGDDGDLFWAHTGGGGGNFGIITKYYFKDLPMSPRGVIASNLHFSWDGFTRDALQDLLTKYFKLARCDWKNTVGKFQIFHQAAEEFVMYLYTSYSNDAEREVAQDRHYHLEADIEQIYKTCEPTKALGGHAGWAPFPVRPRKRHTSKTSYIHDETMDYPFYALTETINGSGPNQRGKYKSAYMIKDFPDLQIDVIWKYLTEVPDGLTSAEMKDALLQVDMFGGEIHNVAWDATAVAQRKYIIKLQYQTYWQEEDKDAVNLKWIRDFYEEMYEPYGGVPDPNTQVESGKGVFEGCYFNYPDVDLNNWKNGKYGALELYFLGNLNRLIKAKKLWDPNEIFTNKQSIPTKSLKEYKQTK